(19) United States
(12) Patent Application Publication
(10) Pub. No.: US 2024/0140214 A1
(43) Pub. Date: May 2, 2024

(54) ELECTRIC BICYCLE WITH WIRELESS CHARGING

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/385,258

(22) Filed: Oct. 30, 2023

Related U.S. Application Data
(60) Provisional application No. 63/420,482, filed on Oct. 28, 2022.

(51) Int. Cl. B60L 53/12; B62J 43/13; H02J 50/10; H02J 50/90

(52) U.S. Cl. CPC B60L 53/12; B62J 43/13; H02J 50/10; H02J 50/90; B60L 2200/12

(57) ABSTRACT

One or more examples provide an electric bike having a hands-free inductive charging system.

### CROSS REFERENCE TO RELATED APPLICATION

This Non-Provisional Patent Application claims the benefit of the filing date of U.S. Provisional Patent Application Ser. No. 63/420,482, filed Oct. 28, 2022, which is herein incorporated by reference.

### TECHNICAL FIELD

The present disclosure relates generally to examples of electric vehicle charging.

### BACKGROUND

Electric vehicles (EVs), such as automobiles (e.g., cars and trucks), snowmobiles, personal watercraft (PWC), all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a rechargeable battery system, one or more electrical motors, each with a corresponding electronic power inverter (sometimes referred to as a motor controller), and various auxiliary systems (e.g., cooling systems). To enhance ownership and ensure availability, charging of EVs should be both timely and convenient.

For these and other reasons, there is a need for the present invention.

### SUMMARY

The present disclosure provides one or more examples of an electric vehicle and systems and/or devices for use with an electric vehicle.

In one example, the present disclosure provides an electric bicycle. The electric bicycle is configured for wireless charging.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems.

FIG. 1 is a diagram illustrating one example of an electric bicycle.

FIG. 2 is a block diagram illustrating one example of an electric bicycle.

FIG. 3 illustrates one example of an inductive charging device.

FIG. 3A illustrates another example of an inductive charging device.

FIG. 4 illustrates another example of an inductive charging device.

FIGS. 5A-5B are block and schematic diagrams generally illustrating an inductive charging system, according to examples of the present disclosure.

FIG. 6 is a block and schematic diagram generally illustrating an inductive charging system, according to examples of the present disclosure

FIG. 7 is a block and schematic diagram generally illustrating an inductive mat for use with an EV charging system, according to examples of the present disclosure.

FIG. 8 is a block and schematic diagram generally illustrating an inductive mat for use with an EV charging system, according to examples of the present disclosure.

FIG. 9 is a block and schematic diagram generally illustrating an inductive mat for use with an EV charging system, according to examples of the present disclosure.

FIG. 9A is a block and schematic diagram generally illustrating portions of an inductive mat for use with an EV charging system, according to examples of the present disclosure.

FIGS. 10A-10C are block and schematic diagrams generally illustrating an inductive mat for use with an EV charging system, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Conventional approaches to charging electric vehicles (EVs) typically include plugging a power cord into a receptacle on the vehicle. While effective for charging EVs, such approach requires a user to exit the vehicle to insert the power cord, which can be undesirable in inclement weather and may also be difficult for persons having physical disabilities. Also, upon arriving at a destination, such as the user's home garage, for instance, the user may forget to plug the vehicle into the charger, and within the garage, a power cord extending between the charger and the vehicle may present an obstacle.

Wireless charging techniques, including inductive charging systems, may require less user interaction to effect EV charging. Inductive charging systems typically employ a charging station having a transmitting coil which is controlled to create a fluctuating magnetic field which induces and alternating current is a receiving coil of the EV, with the alternating current, in-turn, being rectified to provide DC charging power. Misalignment between transmitting (source) coils of the charging stations and the receiving (destination) coils reduces the efficiency of the charging system. Thus, inductive charging systems typically employ some type of alignment system to achieve desired alignment between the transmitting and receiving coils.

Known alignment systems typically include mechanisms to provide horizontal movement between the transmitting and receiving coils, and often require active involvement of the driver, such as the driver needing to adjust the physical position of EV to better align the receiving coil with the transmitting coil of the charging station, which can be cumbersome, particularly in confined spaces (such within a user's garage, for example). Additionally, such positioning systems can add to the cost and complexity of the vehicle.

The following disclosure includes one or more examples of electric vehicles (EVs) with charging port devices and charging port devices and/or charging devices/systems for use with electric vehicles. One or more features of electric vehicle systems and devices are described in further detail in the following paragraphs and illustrated in the Figures. In one example, the present application discloses an electric bike having a wireless charging system. The electric bike is parked on the inductive charger when not in use, hands free and wireless charging the electric bike.

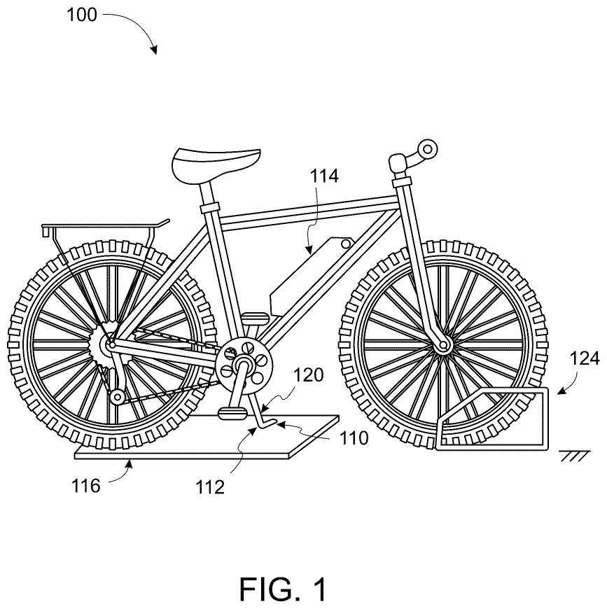

FIG. 1 is a diagram illustrating one example of an electric bike generally at 100. The electric bike 100 includes a wireless charging system 100. In one example, the wireless charging system 110 is an inductive charging system. In another example, the wireless charging system 110 is a contact charging system.

In one example, the wireless charging system 110 is an inductive charging system. The inductive charging system includes an inductive charging device 112. The inductive charging device 112 is electrically coupled to the bike battery pack 114. The inductive charging device 112 works with an inductive charger 116 for charging the bike battery pack 114. In one example, the inductive charger 116 is in the form of a charging mat.

In order to charge the electric bike 100 battery pack 114, the electric bike 100 is positioned over the inductive charger 116. The inductive charging device 112 is lowered to contact the inductive charger 116, to inductively couple the bike 100 inductive charging device to the inductive charger 116. The battery pack 114 is charged via the inductive charging device 112.

The bike 100 includes a kickstand 120. The kickstand 120 operates to support the bike when parked or when not in use. In one example, the kickstand 120 includes the inductive charging device 112. In operation, the kickstand 120 physically operates to support the bike in an upright position when not in use, and electrically operates to aid in charging the electric bike 100. When the bike 100 is parked at a location where the kickstand is positioned over the inductive charger 116, the weight of the bike aids in positioning and tensioning the inductive charging device 120 against the inductive charger 116.

In another example, the inductive charging device 112 is operably coupled to the charging device. The bicycle 100 is supported by a separate kickstand, or supported in a different manner such as with an independent bike stand 124.

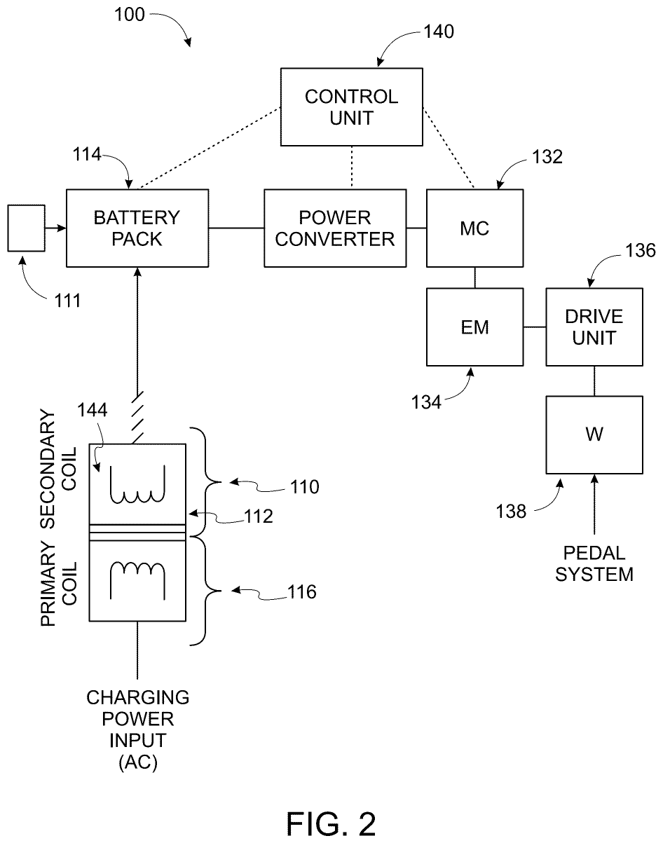

FIG. 2 is a block diagram illustrating one example of an electric bike 100, including the wireless charging system 110. The wireless charging system 110 is illustrated electrically coupled to an inductive charger 116 such as a charging mat.

The electric bike 100 includes battery pack 114, a power converter 130, a motor controller 132, an electric motor 134, a drive unit 136, wheel system 138, and control unit 140. Control unit 140 controls the operation of the electric bike 100. Battery pack 114 includes one or more DC batteries. The electric bike 100 is powered via battery pack 114. Power converter 130 includes a DC/AC converter for converting the battery pack 114 DC voltage output to an AC voltage output. Motor controller 132 controls electric motor 134 coupled to drive unit 136. Drive unit 126 is mechanically coupled to wheel system 138 for mechanically driving at least one bike wheel. Alternatively, the electric bicycle 100 wheel system can be manually driven via pedal system 142.

Battery pack 114 is charged via electric charging system 112. The electric charging system 112 is an inductive charging system, and includes a secondary charging coil 144. The electric charging system 112 inductively couples to inductive charger 116 for charging 116. In one example, the inductive charging system 112 secondary charging coil 144 is located in the kickstand 120.

In one example, electric bike 100 also includes a charging port 111 coupled to battery pack 114. The charging port 111 allows electric bike 100 to be charged by plugging it into a charging station via charging port 111.

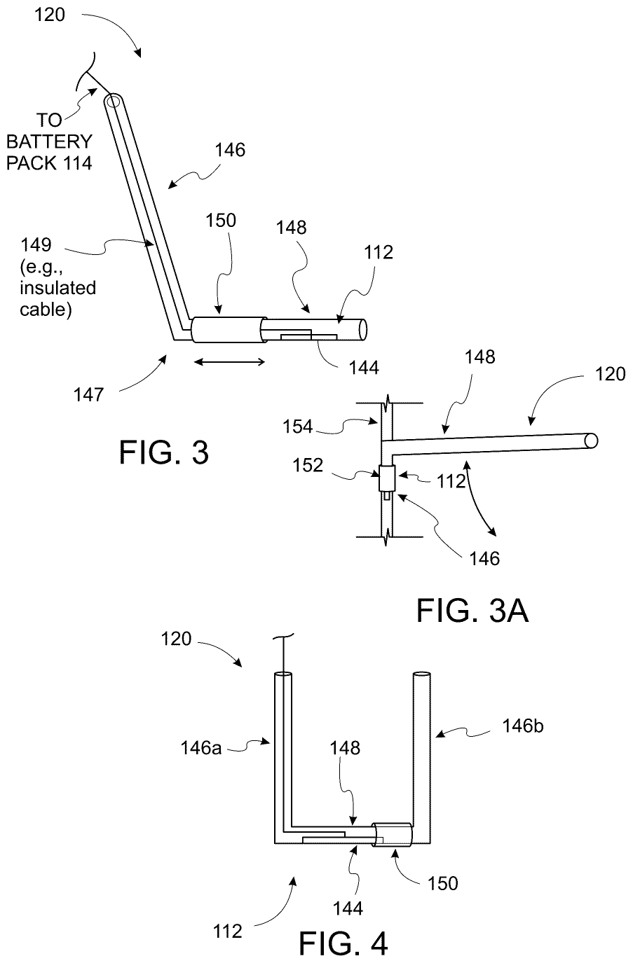

FIG. 3 illustrates one example of kickstand 120. The kickstand 120 operates to both support electric bike 100 when not in use, and includes an inductive charging device 112 for wireless charging of the electric bike 100. The kickstand 120 is generally L shaped, and includes a first support member 146 and a second support member 148. When in use, the first support member 146 extends downward from the bike 100, and the second support member 148 extends outward from the first support member 146 at a support member interface 147. The second support member 148 includes the inductive charging device 112 having a secondary coil 144. The inductive charging device is electrically coupled to battery pack 114 through first support member 146, illustrated at 149.

The kickstand 120 includes a cleaning device 150. The cleaning device 150 is movable along second support member 148. In one example, the cleaning device is manually movable across inductive charging device 112 for cleaning contact surfaces of inductive charging device 112. In another example illustrated in FIG. 3A, a cleaning device 152 is coupled to electric bike 100 frame 154. When the bike is in use, the kickstand 120 is in an up position against bike frame 154. Cleaning device 152 is connected to frame 154. Each time the kickstand 120 is moved (i.e, between) from an up position to a down extended position for supporting and/or inductive charging of the bike, the cleaning device 152 operates to clean the contact surfaces of inductive charger 112.

In one example, cleaning device 150 is made of a hand, polymeric material, and includes an interior cleaning surface. In one or more examples, the cleaning surface is made of a microbrush, a microfiber, a suede, or other cleaning material.

FIG. 4 illustrates another example of inductive charging device 112. The inductive charging device 112 is generally u-shaped, and can operate both as a kickstand 120 and inductive charging device 112. The charging device includes a first leg 146a, a second leg 146b, and a charging leg 148 that contract inductive charger 116. Alternatively, the inductive charging device 112 only operates as a charging device and does not operate as a kickstand to support the bike 100.

In another example, the wireless charging system is a electromagnetic charging system. The wireless charging device magnetically couples to the charger.

One or more examples of a charging mat suitable for use with the electric bike 100 wireless charging system 110 is disclosed in the following paragraphs. The charging mat provides a primary coil as part of inductive charger 116 for charging the electric bike 100.

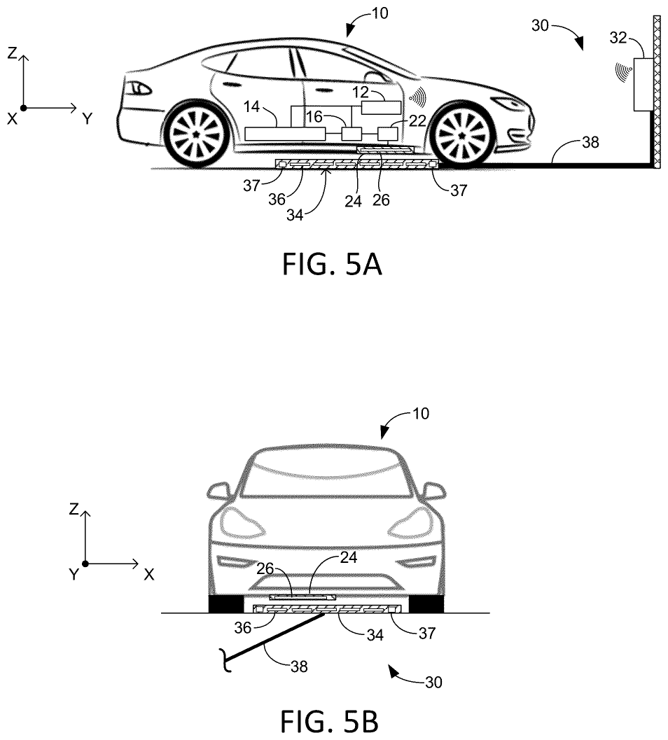

FIGS. 5A and 5B are block and schematic diagrams which generally illustrate an inductive charging system 30, in accordance with the present disclosure, and which is shown with respect to side and front views of an EV 10. In examples, inductive charging system 30 includes a controller 32, a charging mat 34, and a cable connection 38 (e.g., power and communications wiring) electrically connecting controller 32 with charging mat 34. In examples, charging mat 34 includes a number of individually controllable transmitting coils 36 and a number of proximity sensors 37 to detect a presence of a vehicle (e.g., see FIGS. 2-5 below). In examples, EV 10 includes a controller 12, a rechargeable battery 14, a battery charger 16, a power conditioning module 22, and a charging panel 24 including at least one receiving coil 26 disposed on the underside of EV 10, and a power conditioning module 24.

In examples, as illustrated, and as will be described in greater detail below, charging mat 34 (and transmitting coils 36 disposed therein) is configured to be disposed on a surface of a parking area (e.g., on a floor of a residential garage) so that an EV, such as EV 10, can be driven there over to dispose charging panel 24 vertically above charging mat 34. In examples, the x- and y-dimensions of charging mat 34 (and the array of transmitting coils 36 disposed therein) are greater than those of charging panel 24 (and receiving coils 26) to enable easy and reliable positioning of charging panel 24 over charging mat 34 without requiring a positioning system to guide the driver and/or EV. In examples, charging mat 34 is sized to ensure that transmitting coils 36 extend beyond the perimeter dimensions of charging panel 24 in the x- and y-directions. In examples, as part of an installation procedure, charging mat 34 is easily moveable so as to be positioned on the floor at a location that generally aligns with the position of the charging panel 24 on a given EV 10 when parked in the parking/charging space (e.g., some EVs may have a charging panel positioned at the front driver side of the vehicle, whereas another EV may have a charging panel positioned at the rear passenger side of the vehicle).

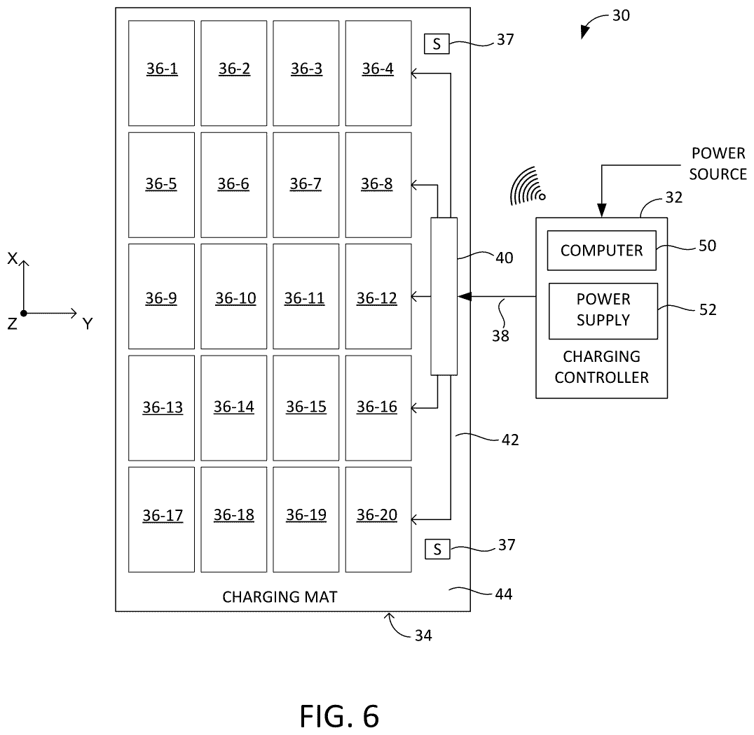

The larger dimensions (i.e., surface area) of charging mat 34 enables the entire surface area of charging panel 24 (and, thus, receiving coils 26) to be generally physically positioned vertically above the transmitting coils 36 (i.e., in the z-direction) without use of a positioning system. As will be described in greater detail below, in accordance with the present disclosure, a layout of transmitting coils within charging mat 24 and selective energization of transmitting coils 36 by charging controller 32 enables electric/magnetic alignment between receiving coil(s) 26 of charging panel 24 and selected transmitting coils 36 of charging mat 34 to provide efficient charging. In other words, charging system 10, in accordance with the present disclosure, allows imprecise physical positioning between charging plate 24 and charging mat 34 while still providing accurate electric/magnetic alignment between transmitting coil(s) 36 and receiving coil(s) 26 without a need for cumbersome and complicated physical positioning systems that horizontally adjust the physical positions of charging panel 24 and charging mat 34 relative to one another. In some examples, charging mat 34 further includes a vertical positioning system 60 (see FIG. 6) that enables charging mat 34 to be moved vertically (in the z-direction) to be positioned closer to, or in contact with, charging panel 24 and thereby improve the charging efficiency of charging system 10 (e.g., see FIGS. 6A-6C).

FIG. 6 is a block and schematic diagram generally illustrating an example of inductive charging system 30, according to the present disclosure. Charging mat 34 includes a plurality of transmitting coils 36, indicated as charging coils 36-1 to 36-20 in the illustrated example. In one example, as illustrated transmitting coils 36 are arranged in an array-like fashion, with transmitting coils 36-1 to 36-4 forming a first row 39-1, coils 36-5 to 36-8 forming a second row 39-2, coils 36-9 to 36-12 forming a third row-39-3, coils 36-13 to 36-16 forming a fourth row 39-4, and coils 36-17 to 36-20 forming a fifth row of coils 39-5. As illustrated in FIG. 6, transmitting coils 36 are arranged in a 5×4 array (i.e., 5 rows by 4 columns). However, it is noted that transmitting coils 36 may be disposed in any number of suitable arrangements other than a rectangular array. Additionally, while transmitting coils 36 are illustrated as being non-overlapping with one another in the example of FIG. 6, in other examples, such as illustrated by FIGS. 5 and 5A, transmitting coils 36 may be disposed so as to overlap with one or more adjacent transmitting coils.

In examples, charging mat 34 additionally includes one or more sensors 37, such as proximity sensors, to detect the presence of an EV, such as EV 10, when positioned vertically above charging mat 34. In one example, sensors 37 comprises inductive sensors.

In examples, charging mat 34 further includes a number of controllable power switches 40 which are selectively operable by changing controller 32 to separately provide power to each transmitting coil 36 and to energize selected combinations of transmitting coils 36. In examples, transmitting coils 36, controllable power switches 40, and power wiring 42 are sealed within a material 44 which comprises a waterproof, electrically insulating material (e.g., a rubber, plastic, resin, thermoplastic, etc.).

Charging controller 32 includes a computer 50 (e.g., including one or more processors and memory storing instructions for operating charging system 30) configured to direct charging operations of charging system 30, such as charging of EV 10, including controlling operation of controllable power switches 40 and a power supply 52 which provides an oscillating power signal to transmitting coils 36 to generate oscillating magnetic fields to induce oscillating voltages in receiving coil 26. In examples, cable connection 38 includes power and control wiring connecting charging controller 32, including computer 50 and power supply 52, with charging mat 34. In examples, cable connection 38 comprises a flat cable so as to provide a low profile when surface mounted. In examples, cable connection 38 may be encased within a low-profile, impact-resistant housing that can withstand the weight of vehicles and other equipment (e.g., lawn mowers, snow blowers) being driven there over. In examples, charging controller 32 is configured for wireless communication (e.g., via Bluetooth, WiFi, cellular, etc.) with one or more other devices, such as EV 10 and with a cell phone with an application installed thereon which enables a user to communicate remotely with charging controller 32.

According to examples, in operation, proximity sensor(s) 37 detects a presence of EV 10 when driven over charging mat 34 and, in response, charging controller 32 initiates charging communications with EV 10, such as wireless communication (via Bluetooth, Bluetooth low energy). Charging controller 32, via the charging communications, receives indication from EV 10 when it is in a “parked” state, wherein due to the positioning of charging mat 34 on the surface of the designated parking space (e.g., on the floor of a residential garage), receiving panel 24 is vertically disposed over charging mat 34 when EV 10 is in a “parked” state. In examples, charging controller 32 requests the charge level of rechargeable battery 14, and based on the received charge level determines whether to carry out a charging operation. In some examples, if the charging level is below a predetermined level (e.g., below 80%), charging controller 32 initiates a charging operation. In some examples, a driver, via some type of user interface, such as via an on-board vehicle interface or via an application installed on a portable computing device (e.g., a smartphone), may request that a charging operation be performed or not performed, where such request may override the charging decision of charging controller 32 based on the charge level of battery 14 as described above.

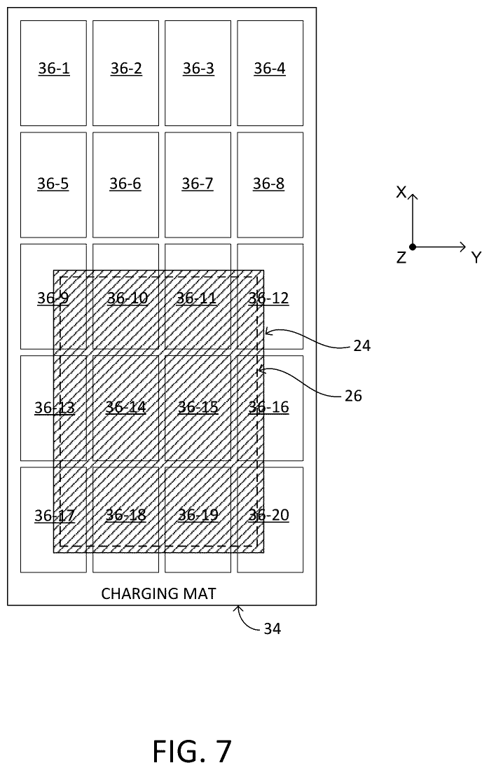

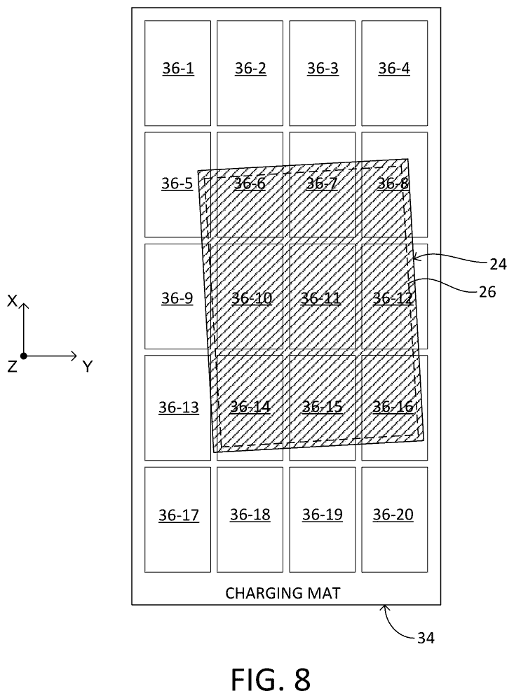

In examples, as also described in greater detail below (e.g., see FIGS. 7 and 8), when a charging operation is to be performed, charging controller 32 initiates a coil selection process by sequentially activating each transmitting coil 36 of charging mat 34 (i.e., one transmitting coil at a time). In response, controller 12 of EV 10 monitors and communicates to charging controller 32 an amount of energy transferred to receiving coil 24 from each individual transmitting coil of charging mat 34, wherein the amount of energy transferred is indicative of the alignment between a given transmitting coil 36 and the receiving coil(s) 26 (i.e., the greater the amount of energy transferred the better the alignment). Based on the amount of energy transferred from each transmitting coil 36, charging controller 32 begins charging battery 14 of EV 10 by selectively energizing those transmitting coils 36 which are best aligned with receiving coil(s) 26. In some examples, charging controller 32 selectively energizes only those transmitting coils 36 which provide an amount of energy transfer above a predetermined threshold level. In some examples, such predetermined threshold level may be a percentage (e.g., 50%, 70%, 80%, etc.) of a maximum amount of energy a given transmitting coil 36 may transfer if fully aligned with a receiving coil of EV 10.

It is noted that, as employed herein, energizing a transmitting coil 36 includes charging controller 32 providing an alternating power signal to a transmitting coil 36 (e.g., alternating voltage) to produce an oscillating magnetic field which inductively induces an alternating current in receiving coil(s) 26 of charging panel 24 of EV 10. In examples, the alternating current generated within receiving coil(s) 26 is received and conditioned by power conditioning module 22 (e.g., rectified and regulated, et al.) before being provided to battery charger 16 to charge battery 14. In examples, during a charging process, charging controller 32 periodically receives a charging status of battery 14 (e.g., such as a percentage of charge level) and charges battery 14 until battery 14 reaches a predetermined charge level or until the vehicle is driven from the charging mat (wherein charging controller 32 terminates the charging process in response to vehicle controller 12 communicating that EV 10 is exiting a charging mode).

FIG. 7 is a block and schematic diagram illustrating a top view of charging mat 34 with charging plate 24 of EV 10 shown as being disposed there over. FIG. 7, in conjunction with FIGS. 1A, 1B, and 2, describes an electric/magnetic alignment process between transmitting coils 36 of charging mat 34 and receiving coil(s) 26 of charging plate 24 of EV 10. As described above, upon sensor(s) 37 indicating the presence of EV 10 over charging mat 34, and upon determining that a charging operation of battery 14 is to be performed (e.g., based on the charge level of battery 14 being below a predetermined level as communicated by vehicle controller 12), charging controller 32 sequentially energizes each of the transmitting coils 36-1 to 36-20 in a predetermined pattern (e.g., in sequence from 36-1 to 36-20).

In response to the energization of each transmitting coil 36 being energized to generate a fluctuating magnetic field to induce an alternating current in receiving coil(s) 26 of charging panel 24, vehicle controller 12 provides to charging controller 32 an indication of the amount of energy transferred to charging panel 24 for each individual transmitting coil 36-1 to 36-20. In examples, charging controller 32 determines which of the transmitting coils 36-1 to 36-20 will be energized to carry out charging of battery 14 based on the corresponding received energy transfer level of each individual transmitting coil 36-1 to 36-20.

In some examples, a given transmitting coil 36 will be energized for a charging operation if its corresponding energy transfer level is at or above a predetermined threshold energy level. In some examples, the predetermined energy level may be a percentage of a maximum energy transfer level of each transmitting coil 36 (e.g., 50% of the maximum energy level). In some examples, each transmitting coil 36 is a same size and has a same maximum energy transfer level. In some examples, transmitting coils 36 may be of different sizes and have different maximum energy transfer capacities, such that the predetermined energy level may be unique for each transmitting coil 36. For example, in some cases, transmitting coils 36 positioned along the perimeter edges of charging mat 34 may be smaller in size than transmitting coils 36 positioned toward and interior of charging mat 34 to provide improved granularity of energization overlap between transmitting coils 36 and receiving coil(s) 26 (so that, when energized, portions of transmitting coil(s) 36 along perimeter edges of charging mat 36 which do not overlap with receiving coil(s) 26 are minimized so as to minimize inductive heating of metallic portions of EV 10 adjacent to charging panel 24.

For instance, in the illustrated example of FIG. 7, in one case, based on the received energy transfer level and corresponding predetermined energy level of each of the transmitting coils 36-1 to 36-20, charging controller 32 energizes each of the transmitting coils 36-9 to 36-20 to charge battery 14, while transmitting coils 36-1 to 36-8 are not energized. In another example, charging controller 32 may energize only transmitting coils 36-10, 36-11, 36-14, 36-15, 36-18, and 36-19, while the remaining transmitting coils are not energized during charging of battery 14.

FIG. 8 is a block and diagram illustrating another example of charging plate 24 of EV 10 being disposed over charging mat 34, wherein charging plate 24 is at an oblique angle relative to charging mat 34. In one example, based on the received energy transfer level of each transmitting coil 36-1 to 36-1, charging controller 32 may elect to energize only transmitting coils 36-6 to 36-8, 36-10 to 36-12, and 36-14 to 36-16 to charge battery 14 of EV 10.

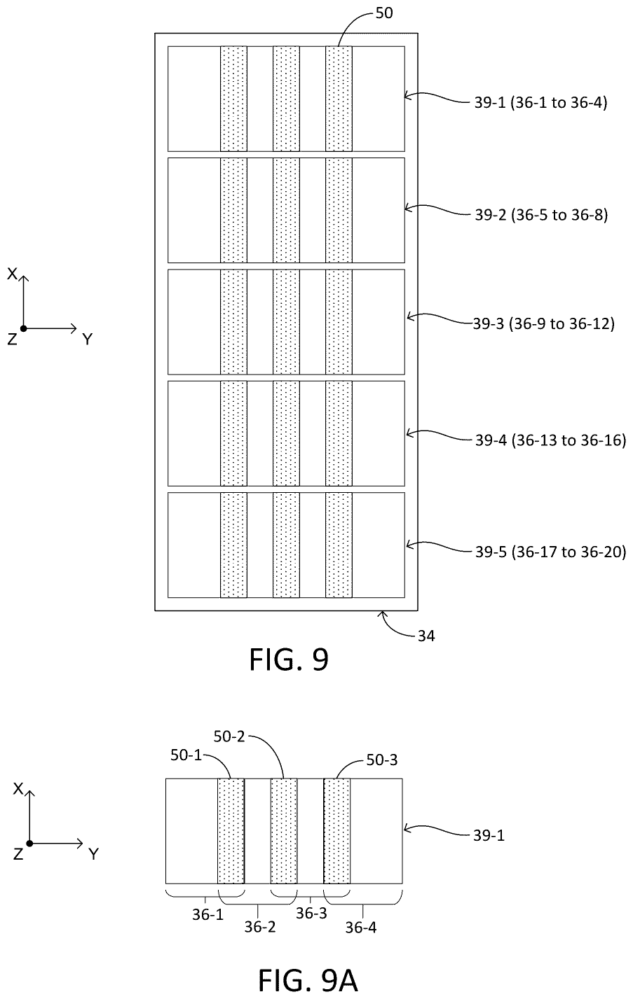

FIG. 9 is block and schematic diagram generally illustrating a top view of charging mat 34, according to one example. In the example of FIG. 9, the transmitting coils 36 of each row 39-1 to 39-5 of transmitting coils are positioned so as to partially overlap with one another in the y-direction, where each of the overlap areas are illustrated by the shaded regions 50. FIG. 9A is block and schematic diagram generally illustrating row 39-1 in greater detail, where shaded region 50-1 indicates the overlap region between transmitting coils 36-1 and 36-2, shaded region 50-2 indicated the overlap region between transmitting coils 36-2 and 36-3, and shaded region 50-3 indicates the overlap region between transmitting coils 36-3 and 36-4. While not illustrated in FIGS. 5 and 5A, in some examples, transmitting coils 36 may be positioned so as to overlap in the x-direction. In some examples transmitting coils 36 may be positioned so as to overlap in both the x- and y-directions.

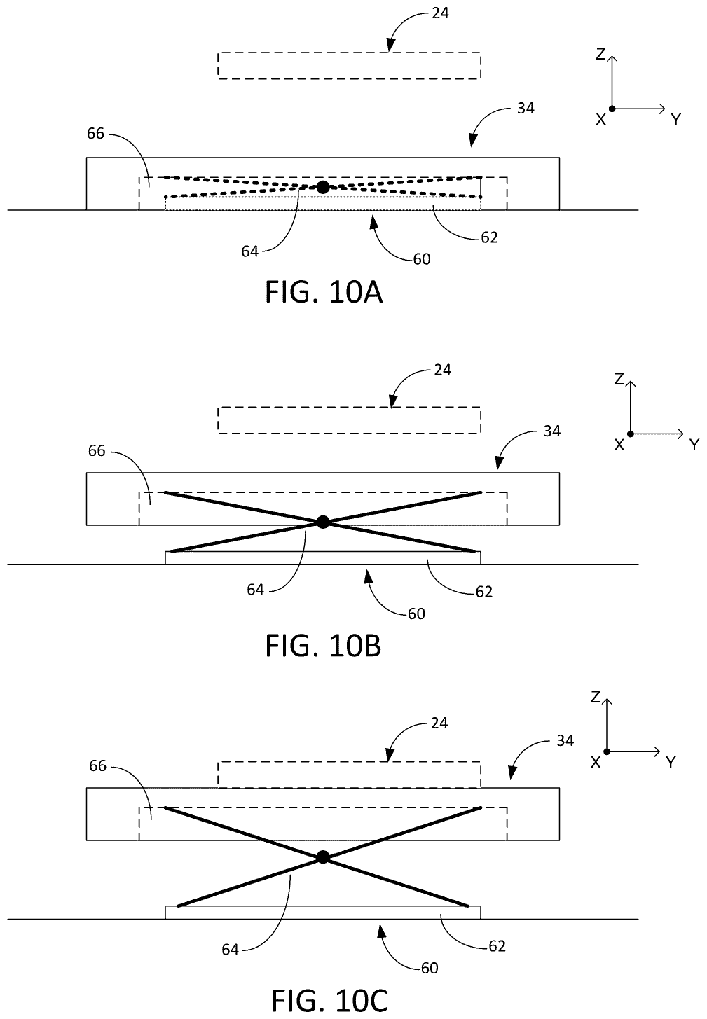

FIGS. 10A-10C are block and schematic diagrams generally illustrating charging mat 34, according to one example, wherein charging mat 34 further includes a vertical positioning system 60 to move charging mat 34 (and transmitting coils 36 disposed therein) up and down in the z-direction so as to be flush with charging panel 24 during a charging operation, and disposed on the floor surface when inactive. In one example, vertical positioning system 60 comprises a scissor-jack configuration having a base element 62 and a set of scissor arms 64 which can be controlled by charging controller 32 to raise and lower charging mat 34 in the z-direction (i.e., vertical direction). In one example, vertical positioning system 60 is disposed within a recess 66 in the bottom side of charging mat 32. Raising charging mat 34 so as to be in contact with charging panel 24 during a charging procedure improves efficiency of the charging process.

As should be understood by those in the field of inductive charging, it is noted that charging system 30 may be configured for tightly coupled charging (TCC) approaches or for loosely coupled charging (LCC) approaches.

In summary, inductive charging system 30 disclosed herein provides efficient inductive charging of an EV while requiring little to no user/drive involvement. Inductive charging system 30 eliminates the need for alignment systems which involve horizontal movement of transmitting coils and/or receiving coils to achieve alignment there between, thereby reducing the cost and complexity of an inductive charging system for both the EV and the charging system. Inductive charging system 30 also provides hands-free charging, which can be especially valuable to users having physical disabilities. Furthermore, inductive charging system 30 can be configured to automatically charge an EV with no user input, thereby eliminating a scenario where a user may inadvertently forget to initiate a battery charging procedure (e.g., forget to plug the EV into the charger).

The ideas of the present application can be applied to home electrical systems, and also to other facilities such as industrial or municipal facilities for load management and smart metering.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric bike comprising:
a bike frame;
a battery pack;
a bike stand movably coupled to the bike frame; and
a charging device integrated into the bike stand.

2. The electric bike of claim 1, where the bike stand comprises a kickstand.

3. The electric bike of claim 1, where the charging device is an inductive charging device.

4. The electric bike of claim 3, the charging device including a secondary charging coil.

5. The electric bike of claim 4, comprising an inductive charger having a primary charging coil that inductively couples to the inductive charging device.

6. The electric bike of claim 5, where the inductive charger is a charging mat.

7. The electric bike of claim 6, where the charging mat comprises multiple primary charging coils.

8. The electric bike of claim 1, where the charging device is a contact charging device.

9. An electric bike comprising:
a bike frame;
a battery pack coupled to the bike frame for powering the electric bike;
a bike kickstand movably coupled to the bike frame; and
a charging device integrated into the bike kickstand, the bike kickstand operably positioned to both support the electric bike when not in use and includes the charging device for charging the battery pack.

10. The electric bike of claim 9, where the charging device is an inductive charging device and includes a secondary charging coil.

11. The electric bike of claim 9, where the bike kickstand includes a support member that contacts a charging device, the support member including the charging device.

12. The electric bike of claim 11, where the charging device is an inductive charging device having a secondary charging coil.

13. The electric bike of claim 9, where the kickstand is generally L shaped and includes a first support member and a second support member, and when in an operating position the first support member extends downward from the bike, and the second support member extends outward from the first support member.

14. The electric bike of claim 13, where the second support member includes an inductive charging device having a secondary coil.

15. The electric bike of claim 14, where the inductive charging device is electrically coupled to the battery pack through the first support member.

16. The electric bike of claim 14, the kickstand including a cleaning device movable along the second support member to clean a contact surface of the inductive charging device.

17. The electric bike of claim 14, comprising a cleaning device coupled to the bike frame for cleaning a contact surface of the charging device when the kickstand is moved between an up position and a down operating position.

18. The electric bike of claim 9, where the kickstand is generally U shaped and includes a first support member, a second support member, and the charging device; and when in an operating position the first support member and second support member extend downward from the bike, and the charging device extends between the first support member and the second support member in a charging position, and where the charging device includes an inductive charging device having a secondary coil.

19. The electric bike of claim 18, comprising a cleaning device movably positioned along the charging device.

20. An electric bike comprising:
a bike frame;
a battery pack coupled to the bike frame for powering the electric bike;
a bike kickstand movably coupled to the bike frame;
an inductive charging device integrated into the bike kickstand, the bike kickstand operably positioned to both support the electric bike when not in use and includes the inductive charging device for inductively charging the battery pack; and
an inductive charging mat including a charging surface that inductively couples to the inductive charging device, the inductive charging mat comprising multiple primary charging coils.
